(19) United States
(12) Patent Application Publication
(10) Pub. No.: US 2011/0180287 A1
(43) Pub. Date: Jul. 28, 2011

(54) IMPLEMENT HAVING A HYBRID DRIVE

(75) Inventor: Otto W. Stenzel, Herrsching (DE)

(73) Assignee: Wacker Neuson SE, Munich (DE)

(21) Appl. No.: 13/122,205

(22) PCT Filed: Oct. 5, 2009
(86) PCT No.: PCT/EP09/07110

§ 371 Date: Apr. 1, 2011

(30) Foreign Application Priority Data
Oct. 6, 2008 (DE) 102008050553.6

(51) Int. Cl. B25F 5/00

(52) U.S. Cl. 173/46

(57) ABSTRACT

An implement has an internal combustion engine and a hydraulic system that can be driven by the internal combustion engine for bringing about a working movement. Furthermore, an energy accumulator is provided for the storage of energy in an accumulation phase in which the output delivered by the internal combustion engine is greater than the output currently required by the hydraulic system, and for the delivery of energy in a discharge phase in which the output delivered by the internal combustion engine is smaller than the output currently required by the hydraulic system. The energy accumulator thus serves for balancing output peaks and valleys such that the internal combustion engine may always be operated within an optimum range of rotational speeds.

### BACKGROUND OF THE INVENTION

1. Field of the Invention

The present invention relates to an implement having a drive motor and having a working mechanism that can be driven by the drive motor.

2. Discussion of the Related Art

Such implements are in particular mobile implements such as loaders, telehandlers, baggers, and dumpers. Such implements have in common that their efficiency is generally not very high. Standardly, they must be equipped with high engine output in order to cover the output required for peak loads. Potential energy that is gained when loads are lifted enters the hydraulic system (hydraulic oil) when the loads are lowered, in the form of flow losses. Therefore, a hydraulic cooling unit must be provided that is dimensioned sufficiently large, and that is often combined with a strong ventilator. This results in a high overall consumption of fuel.

### SUMMARY OF THE INVENTION

The object of the present invention is to indicate an implement that can continue to achieve high work output with significantly lower fuel consumption. In addition, the production costs are to be essentially equal to those of a conventional implement; in any case, they are not to be higher.

This object is achieved according to the present invention by an implement having a drive motor, a working mechanism that can be driven by the drive motor via an operative connection in order to bring about a working movement, and an energy accumulator coupled to the operative connection. The energy accumulator absorbs energy in an accumulation phase in which the output of the drive motor is greater than the output currently required by the working mechanism, and outputs energy in a discharge phase in which the output of the drive motor is less than the output currently required by the working mechanism.

An implement according to the present invention has a drive motor, a working mechanism that can be driven by the drive motor via an operative connection in order to bring about a working movement, and an energy accumulator coupled to the operative connection. The energy accumulator is used to store energy in an accumulation phase, in which the output of the drive motor is greater than the output currently required by the working mechanism, and to emit energy in a discharge phase, in which the output of the drive motor is less than the output currently required by the working mechanism. It has turned out that specific working cycles occur in implements, in particular implements of what is known as the compact class, i.e. loaders, telehandlers, baggers, dumpers, etc. This is because in such implements, differing from road vehicles, the load and relief cycles follow one another rapidly, and may even overlap one another. Thus, whereas road vehicles frequently perform work in the same manner over a longer period of time, the implements under consideration in the present application operate in working cycles that are much shorter, but that constantly repeat in a nearly regular fashion.

In the case of a loader, for example, a typical working cycle begins—starting with the emptying of the shovel over a dump truck—with the braking of the loader just in front of the dump truck and the simultaneous lifting and emptying of the shovel. Shortly after this, the empty shovel is lowered, while at the same time, or with a slight temporal delay, the loader accelerates backwards in order to move away from the dump truck. The backward movement is then braked so that the loader can again travel forward. During this traveling movement, the shovel is lowered further and is finally moved with momentum into the material that is to be picked up. After the shovel is tipped in, the arm holding the shovel is raised so that the loader can travel backward without the material contained in the shovel trickling out. After a braking of the rearward movement, the loader is again accelerated forward and the shovel is raised further. When the dump truck is reached, the loader is braked and the shovel is emptied, so that a new cycle can begin. Such a cycle typically runs in a time span of 20 to 30 seconds.

With regard to load, the working cycle of a bagger differs only slightly from this. During the loading of a truck, the bagger lifts its arm, with full shovel, over the side wall, empties the shovel, rotates its revolving superstructure (acceleration and braking), and lowers its arm over the material that is to be picked up. In order to fill the shovel, the arm is bent in and is lifted with simultaneous further bending in until the shovel is full. The arm is then raised, and the rotational movement is simultaneously introduced. Before the unloading position is reached, the rotational movement is braked, and the shovel is finally emptied. A cycle of this sort also generally runs within about 30 seconds.

The working cycles can be repeated over and over again over a long period of time. The process is briefly interrupted only when the dump truck is exchanged, or for example the bagger is moved a few meters. However, low-load and high-load phases also occur during such movement.

During a working cycle, phases having a high output requirement or an output peak (acceleration of the implement, raising the arm, etc.) and phases having an excess output or output valley (braking the implement, braking the rotational movement of a revolving superstructure, lowering the arm and the shovel, etc.) can be observed. In many working processes, two work cycles that consume energy can succeed one another multiple times.

The provided energy accumulator is therefore intended to cover the difference from the average output. This means that the energy accumulator should at least be dimensioned such that it can store the overall kinetic energy of the braking and lowering movements that immediately succeed one another, or that may overlap one another. This energy can then be used to support the drive motor in the next working movement, or also during travel of the implement.

In this design of a hybrid system, it is possible to make the drive motor, in particular an internal combustion engine, smaller, because the internal combustion engine no longer has to cover the peak loads. These peak loads, which go beyond the average load, can instead be absorbed by the energy accumulator.

The internal combustion engine can then be operated with almost constant load. All output peaks and valleys deviating from this average engine output during a typical work cycle can be stored in the energy accumulator or drawn from the energy accumulator. The content of energy in the energy accumulator is then approximately the same at the beginning of each work cycle.

An electric motor that can be operated as a generator in the accumulation phase and as a motor in the discharge phase can be provided as a clutch between the operative connection and the energy accumulator.

Thus, in generator operation the electric motor converts kinetic energy, introduced into the operative connection either by the drive motor or by the working mechanism, into electric current. This current can then be supplied to the energy accumulator.

In the discharge phase, the current from the energy accumulator can be supplied to the electric motor, which is then operated as a motor and introduces kinetic energy into the operative connection. This kinetic energy is then available to the working mechanism in addition to the energy coming from the drive motor, and in this way supports the drive motor.

A differential mechanism can be provided in the operative connection between the drive motor and the electric motor. This makes it possible to operate the electric motor in a rotational speed range that is favorable for this motor. In particular, it can be advantageous to operate the electric motor with a higher rotational speed in order in this way to improve its efficiency.

The electric motor coupled to the operative connection can be seated as a motor directly on the main drivetrain, or can be coupled via the differential mechanism. Here it is to be noted that the rotational speed of the main drivetrain need not be constant under all operating conditions, so that the voltage and the frequency for the electric motor can vary. The adaptation must therefore take place via a suitable control or power electronics system for the electric motor.

The operative connection between the drive motor and the working mechanism can be separable via a clutch. In this way it can be achieved that, in particular when the working mechanism is feeding energy back (e.g. during braking of the implement or lowering of the arm or of the shovel), this energy is not senselessly supplied to the drive motor, which is braking and consuming frictional energy, but rather is supplied completely to the energy accumulator via the electric motor.

The energy accumulator can be an electromechanical (kinetic) accumulator. Such an electromechanical accumulator, also known as a flywheel accumulator, can have an electric motor that can optionally be operated as a motor and as a generator, the energy being storable predominantly in the form of kinetic energy through the rotation of a rotor of the electric motor. The “mechanical battery” DYNASTORE® made by the company Compact Dynamics is an example of a suitable electromechanical or kinetic accumulator.

It has turned out that, due to the many short cycles (seldom longer than 30 seconds), an intermediate storage of energy via an electric accumulator does not make sense with currently available accumulators, due to the limited frequency of cycles. In addition, output peaks and valleys are very large or pronounced, so that conventional energy accumulators that operate purely electrically or electrochemically are not suitable, or are poorly suitable.

The above-named electromechanical energy accumulator is suitable specifically for very short charge and discharge power peaks. The rotor of the electric motor provided in the electromechanical accumulator acts as a flywheel mass that stores the introduced energy. During withdrawal, this electric motor is used as a generator. The rotational speed of the rotor changes during accumulation and withdrawal. The motor/generator voltage and the frequencies thus change in a manner corresponding to the storage level.

In order to achieve good efficiency, the electric motor/generator provided in the electromechanical accumulator (accumulator motor) should be coupled via a converter to the voltage and frequency requirements of the electric motor coupled to the operative connection.

When there is excess output in the operative connection, i.e. in the drivetrain, the excess output can thus first be converted into electric energy by the electric motor coupled to the drivetrain. This energy is suitably transformed by the transformer and is supplied to the electromechanical accumulator, where the electrical energy is used to increase the rotational speed of the rotor of the accumulator motor provided in the accumulator.

If, on the other hand, in the case of an output peak it is determined that the average output provided by the drive motor is not sufficient to operate the working mechanism in a suitable manner (e.g. to raise the arm of a loader), an output need is determined that has to be covered by feeding energy back from the electromechanical accumulator. For this purpose, the accumulator motor is operated as a generator, so that the rotational speed of the rotor decreases. The electrical energy that results from this in the accumulator motor is correspondingly adapted via the transformer and is supplied to the electric motor provided in the drivetrain. This motor supports the drive movement of the drive motor, so that, finally, sufficient output is made available for the working mechanism.

Here, it can be advantageous if these tasks of adaptation to the various rotational speeds and directions of output are carried out by two logically linked, or one common, power and control electronics system.

The working mechanism can have a device selected from the group including:
a rotation device for rotating a component of the implement relative to another component of the implement, in particular relative to a chassis (e.g. a rotational drive for rotating a revolving superstructure of a bagger, or for lifting or rotating an arm, or for rotating or tipping a shovel),
a travelling device for causing the implement to travel (e.g. a chassis and a travel drive),
a lifting device for retracting and extending a piston-cylinder unit (e.g. for the arm and shovel movement).

The working mechanism can have a hydraulic system having at least one hydraulic pump and at least one piston-cylinder unit in order to achieve the desired working movement.

In general, a hydraulic system is made up of a plurality of parallel drivetrains having a pump and a drive unit. The hydraulic pump can be coupled to the operative connection in such a way that it can be operated on the one hand as a pump and on the other hand as a motor. In this way, it is possible for excess power adjacent to the hydraulic system not to be introduced, in the form of heat, into the hydraulic oil via flow losses, but rather to be converted into mechanical energy, with the aid of the hydraulic pump operating as a motor. Thus, when the arm is lowered the hydraulic pump can for example be used to additionally drive the drivetrain, thus introducing power into the drivetrain. This power can then be supplied to the energy accumulator in the manner described above.

It can be advantageous if only a few, or no, throttle valves or proportional control valves are provided in the hydraulic train. Rather, it is useful if as many of the provided valves as possible, or even all of them, are seat valves and/or unlockable check valves. In addition, variable-capacity pumps and motors may be used whose output is adjustable as a function of the required hydraulic pressure and volume.

Throttle valves and proportional control valves have the disadvantage that significant power is lost due to flow losses, which would run counter to the hybrid design outlined above. Instead, therefore, additional seat valves or the unlockable check valves can be used to block a movement. If reversals of the direction of force are necessary (e.g. during pressing with the shovel or rearward-directed withdrawal of the shovel), corresponding changeovers of the routing paths can also be provided via switching valves. Instead of guiding the hydraulic fluid using output-destroying throttle valves and proportional control valves, what is thus sought is for the flow of hydraulic fluid to be as unhindered as possible, or, if a hydraulic flow is not desired, to be completely blocked.

Therefore, in addition a variant is indicated in which the above-described electromechanical accumulator, together with the converter and electric motor, is not present. Rather, in accordance with the above teaching, seat valves, check valves, and/or unlockable check valves are predominantly used in the hydraulic system in order to enable energy-saving operation. In this way, the implement can be built at relatively low cost. In this simplified variant, the intermediate storage of power in the electromechanical accumulator is not required.

In a variant, the working mechanism can have an electric motor/generator combination in order to bring about a work effect. In particular, the work movement can be achieved by an “electrocylinder” that is classically constructed from an electric motor/generator and a spindle.

With the use of electric motors and generators to bring about working movements, efficiency can be further improved because the electrical energy of the electrodynamic energy accumulator does not have to be converted, during storage and withdrawal, via the hydraulic system, which generally has worse efficiency. In the mixed system, for the hydraulic portion the coupling of load in and out takes place via the above-described electric motor/generator in the main train. If, however, a purely electrical system is used having the mentioned “electrocylinders,” the coupling of load in and out for the electric drives can take place directly to and from the drive motors in motor or generator operation.

The common power and control electronics system can be designed to control at least the following parameters: rotational speed of the drive motor; opening and closing of the clutch between the drive motor and the main drive train; accumulation and discharge operation of the energy accumulator; behavior of the hydraulic pumps; position of the hydraulic valves; frequency and voltage at the converter between the electric motor on the main drive train and the energy accumulator.

In a variant, the drive motor can be an internal combustion engine. In addition, a drive electric motor can be provided that is also used to drive the working mechanism via the operative connection, and is suitable to operate the working mechanism alone, without the cooperation of the internal combustion engine. In addition to an electromechanical energy accumulator, a battery (accumulator, capacitor, etc.) can be provided in order to supply the drive electric motor with electrical energy. In the accumulation phase, the output of the internal combustion engine or the drive electric motor should be greater than the output currently required by the working mechanism. In the discharge phase, in contrast, the output of the internal combustion engine or the drive electric motor should be less than the output currently required by the working mechanism. The electrical currents to or from the electromechanical energy accumulator can vary relative to one another more strongly than do the electrical currents to or from the battery.

The drive electric motor must correspondingly be dimensioned large enough to be able to provide the corresponding output. It is then possible to operate the implement exclusively electrically, at least temporarily.

As an energy accumulator for the drive electric motor, a chemical battery (accumulator) or a capacitor or a mixed form thereof may be used, and may cover the basic load. As in the variants described above, in addition to the battery energy accumulator an electromechanical energy accumulator is also provided that compensates the load peaks and valleys. Because of this, the battery does not have to absorb or provide any high current peaks, which is advantageous with respect to its lifespan. Rapid charging or recharging is fundamentally disadvantageous for all chemical batteries, and reduces their current or voltage efficiency as well as their lifespan.

The load peaks that result relative to an average load are thus covered by the electromechanical accumulator. During times with low power draw, or even feeding back of energy due for example to braking of the chassis or lowering of loads, this energy is supplied to the electromechanical accumulator, so that this accumulator is charged in order to release energy in load peaks.

During operation of the internal combustion engine, the drive electric motor can also be operated as a generator in order to charge the battery.

In a variant, the process of charging the battery can thus also take place parallel to operation in weak-load phases, via the drive electric motor, which is then operated as a generator. In this way, the battery can be charged at least with its limited charge current. However, it is also possible to charge the battery while the machine is not being used, via the general power grid, using a charge device.

The hybrid drive for the implement formed by the combination of an internal combustion engine and a drive electric motor can in principle also be operated without the electromechanical energy accumulator. In this variant, however, a smaller part of the released energy in the case of output valleys can be intermediately stored in the battery, output peaks being covered by the simultaneous use of the internal combustion engine and the electric motor (fed by the battery). When there is a low output requirement, for this purpose first the withdrawal of energy from the battery is decreased. Upon further reduction, the battery is charged up to its maximum charge power. Upon further reduction, the internal combustion engine is throttled, and the charging of the battery is continued up to its maximum capacity.

In this variant, therefore, the implement has an internal combustion engine and a drive electric motor that, like the internal combustion engine, acts via the operative connection to drive the working mechanism. The drive electric motor is then suitable to operate the working mechanism by itself, without the cooperation of the internal combustion engine. In addition, a battery is provided for supplying electrical energy to the drive electric motor. In an accumulation phase, in which the output of the internal combustion engine is greater than the output currently required by the working mechanism, energy can be stored in the battery. In the discharge phase, if the output of the internal combustion engine is less than the output currently required by the working mechanism, or if the internal combustion engine is switched off, the drive electric motor is operated by the battery.

The variant described here thus represents a simplified specific embodiment in which no additional electromechanical accumulator is provided for the short-term storage and withdrawal of energy.

The purely electrical drive of the implement has the advantage that the implement can also be used at least for brief periods in enclosed spaces. For example, in agriculture it is standard practice to use loaders both outdoors and in a stall, in alternating fashion. However, when used in a stall the exhaust gases and engine noise of the internal combustion engine are disturbing. On the other hand, in many cases the working phases in the stall require only low output, and are concluded after a relatively short time. Subsequently, longer working periods are to be accomplished outdoors, such as travel operation or loading and unloading of the loading stations in the barn. Here there are enough low-load times in which both the electromechanical accumulator and, parallel thereto, the basic load accumulator (battery) can be charged. Here, the charging power for the battery can be adjusted so as to achieve a long lifespan.

In addition, a method is indicated for controlling a hybrid system or hybrid drive for an implement as described above,
the drive motor being operated with an essentially constant output power;
excess energy resulting from a difference between the output power of the drive motor and a currently lower requirement on the part of the working mechanism being supplied to the energy accumulator;
a lack of energy resulting from a difference between the output power of the drive motor and a currently higher requirement on the part of the working mechanism being withdrawn from the energy accumulator and supplied to the working mechanism.

The constant output power of the drive motor can be dimensioned so that it is lower than a maximum output requirement of the working system. This maximum output requirement (output peak) can be covered instead by the energy stored in the energy accumulator if the energy accumulator is correspondingly adapted to the constant (average) output power of the drive motor.

The components of the implement, in particular the drive motor, the energy accumulator, and the working mechanism, can be dimensioned such that whenever the implement is operated with essentially uniform recurring working cycles, the state of charge of the energy accumulator is essentially the same at the beginning of its working cycle. This ensures that the state of charge of the energy accumulator never sinks so low that sufficient output is no longer available for the operation of the working mechanism.

A method of operating an implement having at least some of the characteristics described above is also disclosed herein.

These and additional features and advantages of the present invention are explained in more detail in the following on the basis of examples, with the aid of the accompanying Figures.

### BRIEF DESCRIPTION OF THE DRAWINGS

FIG. 1 shows a specific embodiment of an implement according to the present invention having a hybrid system, in a schematic representation;

FIG. 2 shows another specific embodiment of the hybrid system;

FIG. 3 shows yet another specific embodiment of the hybrid system; and

FIG. 4 shows an example of the change of the energy content in the energy accumulator over time.

### DETAILED DESCRIPTION OF THE PREFERRED EMBODIMENT

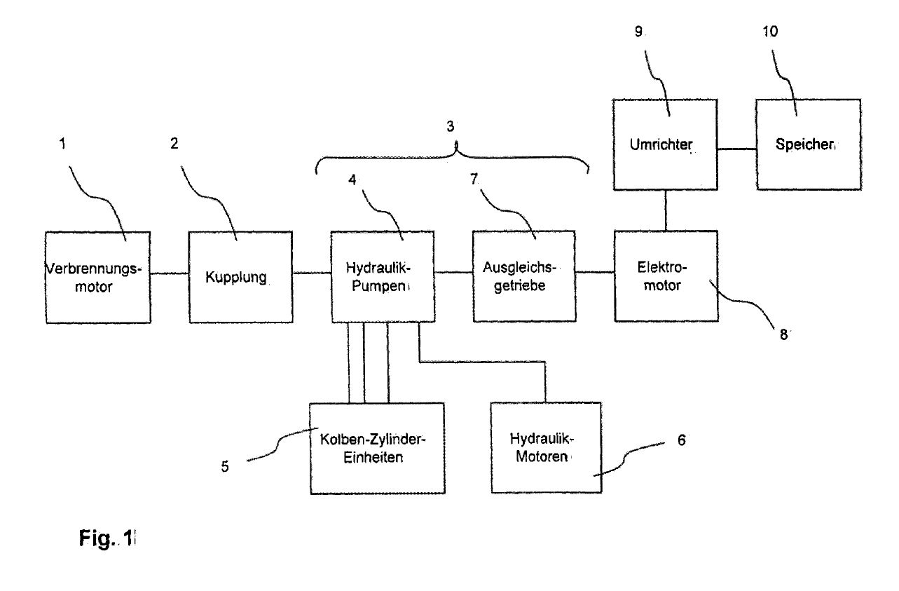

FIG. 1 shows a schematic representation of the design of a hybrid system according to the present invention for an implement.

An internal combustion engine 1 is coupled, via a clutch 2, to a main drivetrain 3 that constitutes an operative connection. With the aid of a clutch 2 that can be controlled by a control device (not shown), it is possible to connect internal combustion engine 1 to main drivetrain 3 or separate it therefrom as needed. This is explained in more detail below. In main drivetrain 3, one or more hydraulic pumps 4 are provided that in normal operation are driven by internal combustion engine 1 in order to convey hydraulic fluid (hydraulic oil) and to place it under pressure in a hydraulic system in a known manner. Correspondingly, hydraulic pumps 4 are connected to one or more piston-cylinder units 5. Piston-cylinder units 5 are used for example to raise and lower the arm of a bagger or loader or to cause a shovel movement.

Likewise, it is possible for hydraulic pumps 4 to be coupled to one or more hydraulic motors 6 in order for example to rotate a revolving superstructure of a bagger relative to its chassis, or in order to provide a travel drive to cause the bagger or a loader to travel in a known manner.

In addition to piston-cylinder units 5 and hydraulic motors 6, suitable valves are provided for controlling the hydraulic flows; however, these valves are not shown in the schematic Figure. These hydraulic valves are preferably seat valves and check valves, or unlockable check valves. Proportional control valves and throttle valves are to be avoided in order to reduce flow losses.

Hydraulic pumps 4, piston-cylinder units 5, hydraulic motors 6, and the hydraulic valves form in this respect a working mechanism of the implement.

Moreover, in main drivetrain 3 there is situated a differential mechanism 7 that connects main drivetrain 3 to an electric motor 8. Electric motor 8 can be operated both as a motor and as a generator. Differential mechanism 7 acts to increase the rotational speed of main drivetrain 3 and to achieve a higher rotational speed suitable for electric motor 8.

Electric motor 8 is connected to an energy accumulator 10 via a converter 9.

Energy accumulator 10 is an electromechanical kinetic accumulator in which there is provided, inter alia, an electric motor (accumulator motor) having a stator and a rotor. The energy that is to be absorbed by energy accumulator 10 is stored in the form of kinetic energy, i.e. rotational energy of the rotor, which also acts as a flywheel mass. The higher the energy content of energy accumulator 10, the higher the rotational speed of the rotor provided therein. Conversely, the energy content of energy accumulator 10 decreases when the rotational speed of the rotor decreases.

The energy accumulator DYNASTORE®, made by the company Compact Dynamics, is an example of a suitable energy accumulator 10.

In addition, a power and control electronics system (not shown in the Figure) is provided that monitors and controls all parameters of the system that are relevant to the method. These include, for example, the rotational speed of internal combustion engine 1, the switching state of clutch 2, the power consumption of hydraulic pumps 4 due to a power requirement on the part of piston and cylinder units 5 and hydraulic motors 6, the position of the hydraulic valves, an excitation at electric motor 8, the behavior of converter 9, and the controlling of energy accumulator 10.

The power and control electronics system adjusts the rotational speed of internal combustion engine 1 to a preset optimal value at which the efficiency of internal combustion engine 1 is particularly high. Depending on the working process currently being executed, this can have the result that excess energy is present that does not have to be introduced into the hydraulic system via hydraulic pumps 4, because the current working process does not require this energy. In this case, the power and control electronics system causes a corresponding excitation of electric motor 8 in order to operate it as a generator. The resulting electrical energy is adapted in its frequency and voltage by the converter and is supplied to energy accumulator 10. The electric motor provided in energy accumulator 10, e.g. a magnetic motor or a reluctance motor, is correspondingly excited so that the rotational speed of the rotor in energy accumulator 10 increases. In this way, energy is stored.

If in a subsequent work process, e.g. the raising of a filled shovel, it is determined that an increased power requirement exists, and the average output of internal combustion engine 1 is not sufficient to cover this power requirement, the power and control electronics system causes additional energy to be fed back from energy accumulator 10.

For this purpose, the electric motor in energy accumulator 10 is operated as a generator, so that the rotating rotor produces an electric current that is supplied to electric motor 8 via converter 9. In this case, electric motor 8 is operated as a motor, and transmits drive power into the main drivetrain via differential mechanism 7. This power is used to support the average power output provided by internal combustion engine 1. In this way, the currently required working cycle can be carried out without having to increase the output power of the internal combustion engine.

In the case of a power excess, e.g. during the lowering of a filled shovel or braking of the chassis, it is also possible to briefly separate internal combustion engine 1 from main drivetrain 3 using clutch 2. At the same time, the rotational speed of internal combustion engine 1 should be regulated so that it does not increase unnecessarily. The power fed back into main drivetrain 3 via the hydraulic system and hydraulic pumps 4 is then fed directly to energy accumulator 10, via differential mechanism 7, electric motor 8, and converter 9. In a following work cycle, it can then again be fed back in the reverse direction in order to support internal combustion engine 1.

Further working and controlling states are conceivable that would require suitable measures on the part of the power and control electronics system in order to make the best possible use of the available energy. Internal combustion engine 1 can be made smaller overall, because it no longer has to cover output peaks, but rather only has to emit a constant average output.

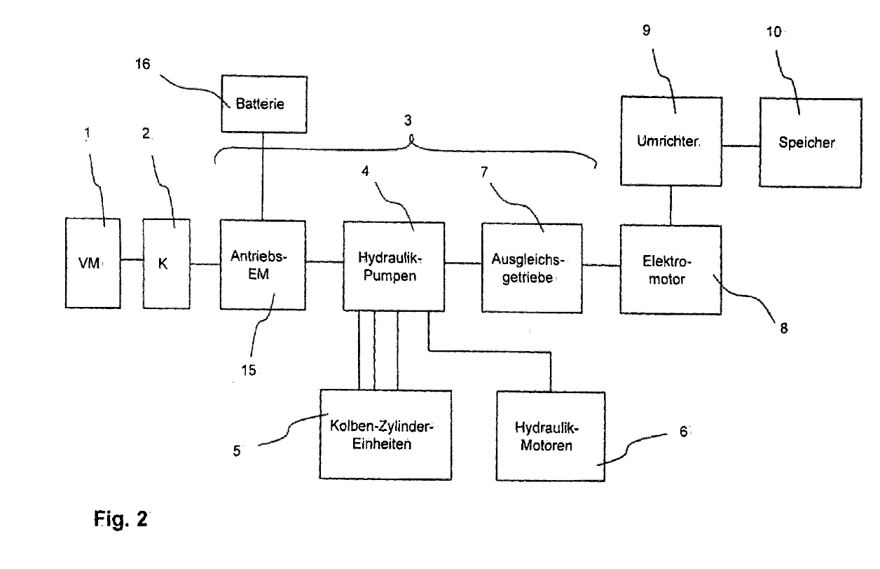

FIG. 2 shows a schematic representation of another specific embodiment. In the main drivetrain, a drive electric motor 15 is provided that is coupled to a battery 16. Drive electric motor 15 is dimensioned large enough to be capable, if necessary, of by itself supplying power to the entire working mechanism of the implement. However, the maximum power output capacity of the battery can be significantly lower than the power rating of the electric motor, because output peaks are covered by the simultaneous use of the battery and the electromechanical accumulator. A further reduction in size of the electric components, the electric motor and the battery, can be realized by briefly additionally using the internal combustion engine with very high output in the case of truly intensive tasks.

Further components, i.e. in particular internal combustion engine 1, clutch 2, and the hydraulic system with hydraulic pumps 4, can be constructed in a manner analogous to the variant shown in FIG. 1.

Drive electric motor 15 makes it possible for the implement to be driven solely electrically over a determined period of time. This period of time is determined by the power requirement of the working mechanism and by the capacity of battery 16. In this context, the term “battery” is to be understood as referring to a capacitor as well as an electrochemical battery (accumulator), or to a mixed form made up of an accumulator and a capacitor. The essential feature is that the electrical energy is stored in chemical-physical form.

Internal combustion engine 1 can be used to charge battery 16 via drive electric motor 15, which is then operated as a generator.

It is possible for the operator to switch optionally between a drive provided by internal combustion engine 1 and a drive provided by drive electric motor 15. This is for example particularly suitable if the implement is temporarily to be operated in enclosed spaces.

A variant also indicated in FIG. 2 additionally includes differential mechanism 7, electric motor 8, converter 9, and energy accumulator 10, which are described above in relation to FIG. 1.

Thus, FIG. 2 shows two variants, namely a variant having only drive electric motor 15, but not having the components required for short-term energy storage, namely differential mechanism 7, electric motor 8, converter 9, and energy accumulator 10. The second variant does include these components.

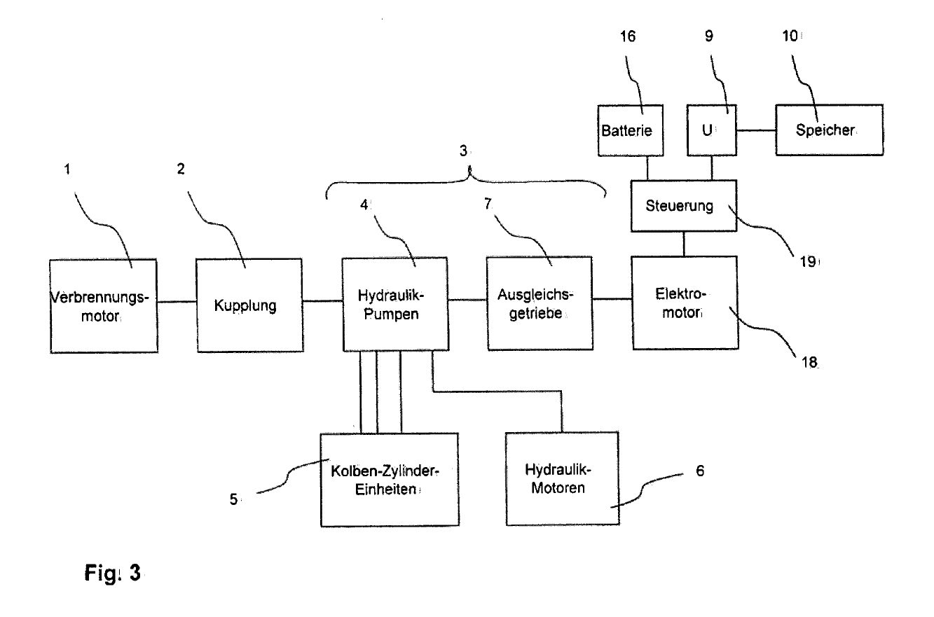

FIG. 3 shows a further variant in which electric motor 8 is combined with drive electric motor 15 to form an electric motor 18. In this way, it is not necessary to provide two separate electric motors 8 and 15.

With the aid of a suitable control electronics system 19, electric motor 18 is connected in a suitable manner to battery 16 and/or to converter 9, in order to withdraw energy from battery 16 or from accumulator 10 or to supply energy back thereto, depending on the operating state.

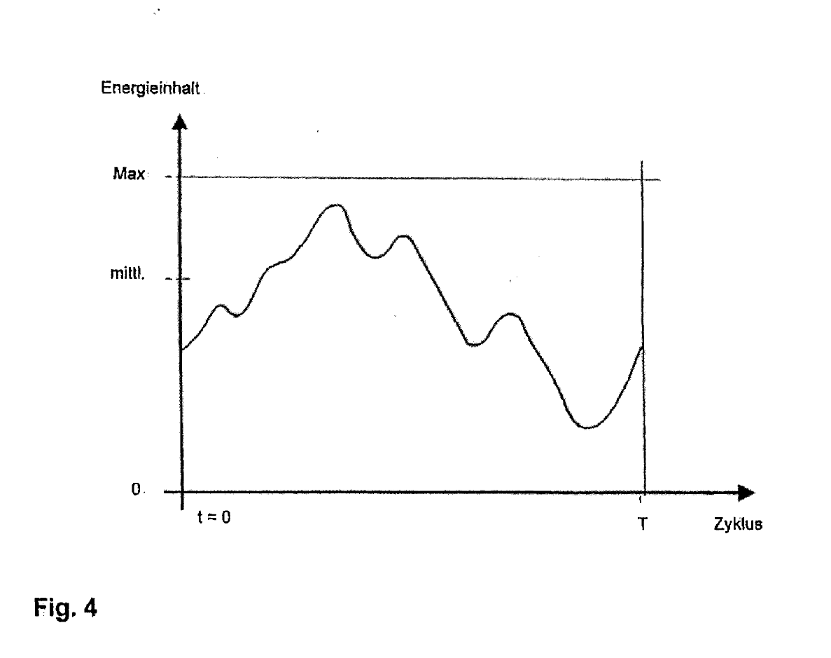

FIG. 4 shows a schematic representation of an example of the curve of the energy content of energy accumulator 10 over time.

Depicted is a working cycle of e.g. 20 to 30 seconds, which is typically multiply repeated by the implement. As shown, the energy content at the beginning of the work cycle (t=0) is equal to the energy content at the end of the work cycle (t=T).

Within the work cycle, the energy content fluctuates strongly, decreasing when there is a power demand on the part of the working mechanism, and increasing when there is a power excess.

Internal combustion engine 1 can be designed so that it constantly provides a power output that ensures that the energy accumulator is never completely emptied. Energy accumulator 10 is to be designed such that it is completely filled only in exceptional cases. As FIG. 4 shows, the energy content then ideally reaches neither the maximum value (Max) nor the minimum value (0).

1. An implement, comprising:
a drive motor;
a working mechanism that can be driven by the drive motor via an operative connection in order to bring about a working movement;
an energy accumulator coupled to the operative connection in order to absorb energy in an accumulation phase in which the output of the drive motor is greater than the output currently required by the working mechanism, and in order to output energy in a discharge phase in which the output of the drive motor is less than the output currently required by the working mechanism.

2. The implement as recited in claim 1, further comprising an electric motor provided as a clutch between the operative connection and the energy accumulator, wherein the electric motor is operable as a generator in the accumulation phase and as a motor in the discharge phase.

3. The implement as recited in claim 1, further comprising a differential mechanism that is provided in the operative connection between the drive motor and the electric motor.

4. The implement as recited in claim 1, wherein the operative connection between the drive motor and the working mechanism is separateable by a clutch.

5. The implement as recited in claim 1, wherein the energy accumulator comprises an electromechanical accumulator.

6. The implement as recited in claim 1, wherein
the electromechanical accumulator has an electric motor that is operable as a motor and as a generator; and wherein
the energy is predominantly storable in the form of kinetic energy through a rotation of a rotor of the electric motor.

7. The implement as recited in claim 1, wherein the working mechanism has a device selected from the group consisting of:
a rotational device for rotating a component of the implement relative to a chassis,
a travel device for causing the implement to travel, and
a piston device for retracting and extending a piston-cylinder unit.

8. The implement as recited in claim 1, wherein the working mechanism has a hydraulic system having at least one hydraulic pump and at least one of a piston-cylinder unit and a hydraulic motor.

9. The implement as recited in claim 8, wherein the hydraulic pump is coupled to the operative connection in such a way that it is selectively operable as a pump and as a motor.

10. The implement as recited in claim 1, wherein the working mechanism includes a hydraulic drive train, wherein the hydraulic drive train lacks throttle valves and proportional control valves and includes at last one of seat valves and unlockable check valves and variable-capacity pumps and motors, and wherein outputs of the variable-capacity pumps and motors can be adjusted as a function of a required hydraulic pressure and hydraulic volume.

11. The implement as recited in claim 1, wherein the working mechanism has at least one electric motor/generator combination that brings about the working movement of the working mechanism.

12. The implement as recited in claim 1, wherein a common power and control electronics system is provided for the common controlling of at least one of the following parameters:
a rotational speed of the drive motor;
opening and closing of an optional clutch;
storage and discharge behavior of the energy accumulator;
conversion behavior of a converter;
a hydraulic pump or a hydraulic system of the working mechanism.

13. The implement as recited in claim 1, wherein
the drive motor is an internal combustion engine;
a drive electric motor is provided that acts via the operative connection to drive the working mechanism and that is suitable to operate the working mechanism by itself without cooperation of the internal combustion engine;
in addition to the energy accumulator, a battery is provided for supplying the drive electric motor with electrical energy;
in the accumulation phase, the output of the internal combustion engine or of the drive electric motor is greater than the output currently required by the working mechanism, and in the discharge phase the output of the internal combustion engine or of the drive electric motor is less than the output currently required by the working mechanism; and wherein
the electric currents to or from the energy accumulator fluctuate proportionately more strongly than do the electric currents to or from the battery.

14. An implement, comprising:
an internal combustion engine;
a working mechanism that can be driven by the internal combustion engine via an operative connection in order to bring about a working movement;
a drive electric motor that acts via the operative connection to drive the working mechanism and that is suitable to operate the working mechanism by itself without cooperation of the internal combustion engine; and
a battery for supplying the drive electric motor with electrical energy.

15. The implement as recited in claim 14, wherein, during operation of the internal combustion engine, the drive electric motor is also operable as a generator for the charging of the battery.

16. A method for controlling a hybrid system of an implement, the implement including a drive motor and a working mechanism that can be driven by the drive motor via an operative connection in order to bring about a working movement, the method comprising:
operating the drive motor with an essentially constant output power;
conducting, to an energy accumulator, excess energy that results from a difference between the output power of the drive motor and a currently lower requirement of the working mechanism;
withdrawing, from the energy accumulator, lacking energy that results from a difference between the output power of the drive motor and a currently higher requirement of the working mechanism; and
supplying the withdrawn energy to the working mechanism.

17. The method as recited in claim 16, wherein the constant output power of the drive motor is dimensioned so that it is lower than a maximum power requirement of the working mechanism.

18. The method as recited in claim 16, wherein
the implement is operated with essentially uniform working cycles; and wherein
the charge state of the energy accumulator is essentially equal at the beginning of each working cycle.
